(19) United States
(12) Patent Application Publication
(10) Pub. No.: US 2014/0372283 A1
(43) Pub. Date: Dec. 18, 2014

(54) DISTRIBUTED LOAN UNDERWRITING

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 13/918,799

(22) Filed: Jun. 14, 2013

(51) Int. Cl. G06Q 40/02

(52) U.S. Cl. CPC G06Q 40/025
USPC 705/38

(57) ABSTRACT

In embodiments, methods, storage media, and apparatuses are described that are associated with underwriting of loans. In various embodiments, offers to underwrite a loan may be received by one or more loan underwriters. Assets and/or lines of credit of the loan underwriters may then be encumbered such that, upon a requirement to pay the loan balance to a lender, the loan balance may be automatically taken from these assets and/or lines of credit. Other embodiments may be described and claimed.

### TECHNICAL FIELD

The present disclosure relates to the field of data processing, in particular, to apparatuses, methods and storage media associated with underwriting of loans.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Individuals and companies frequently borrow money for commercial and personal use. Borrowers frequently need to establish a method of securing a loan in order to convince a lender to lend money. Sometimes this is done through the use of collateral or simply by establishing that the borrower is a good risk for lending. Sometimes the lender may not be able to establish sufficient credit and/or collateral for a loan, however. In such situations, the lender may secure the loan through the establishment of an underwriter, e.g., a person or institution that offers to pay off a balance on the loan in the event of a default. However, borrowers may also find it difficult to identify and make arrangements for loan underwriters.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for loan underwriting, in accordance with various embodiments.

FIG. 2 illustrates an example process for facilitating underwriting of a loan, in accordance with various embodiments.

FIG. 3 illustrates an example process for receiving loan underwriting offers in accordance with various embodiments.

FIG. 4 illustrates an example process for receiving a request for loan underwriting in accordance with various embodiments.

FIG. 5 illustrates an example process for identifying loan underwriters for a loan, in accordance with various embodiments.

FIG. 6 illustrates an example process for sharing underwriting premiums, in accordance with various embodiments.

FIG. 7 illustrates an example process for facilitating a loan balance payment in accordance with various embodiments.

FIG. 8 illustrates an example computing environment suitable for practicing various aspects of the present disclosure, in accordance with various embodiments.

FIG. 9 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

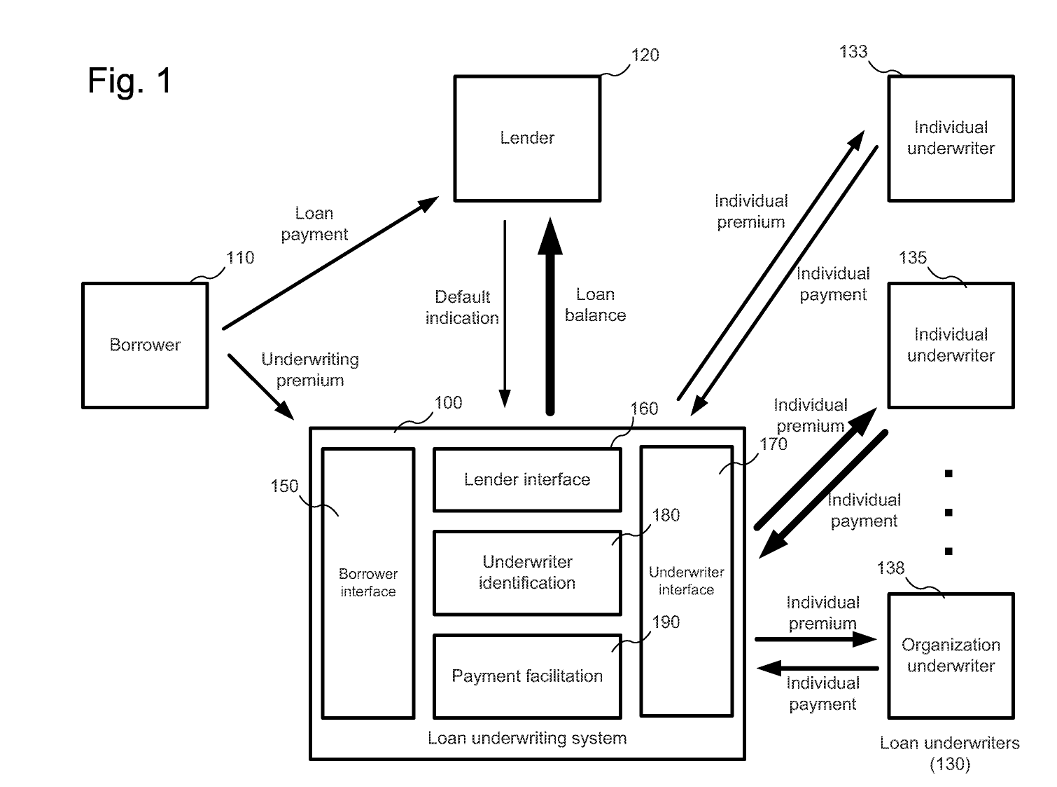

Referring now to FIG. 1, an example arrangement for loan underwriting is shown in accordance with various embodiments. In various embodiments, a loan underwriting system 100 (“LUS 100”) may be configured to interact with a borrower 110 and lender 120 to facilitate underwriting of a loan between the borrower 110 and the lender 120. In various embodiments, the borrower 110 and the lender 120 may operate under a loan agreement whereby the lender 120 provides a loan amount of money to the borrower 110 in exchange for a promise by the borrower 110 to pay one or more loan payments to the lender 120 over a time period, to repay the loan plus interest. In various embodiments, through payment of the loan payments, the borrower 110 may reduce the amount owed on the loan to a loan balance that is less than the original loan amount, typically with a portion of each loan payment going towards the interest, and the remainder of the loan payment going towards reducing the loan owed. In various embodiments, this loan balance may be further lessened by continued payments until the loan balance may reach zero, at which point the loan may be considered to be paid. In various embodiments, while the lender 120 may provide the loan amount of money to the borrower 110, the funds may be sourced from various funding sources that the lender may have access to, including, but not limited to, the lender 120, one or more loan underwriters 130 (such as described below), or other entities.

In various embodiments, the LUS 100 may be configured to facilitate underwriting of the loan by one or more loan underwriters 130. In various embodiments, underwriting of a loan may include an agreement by the one or more loan underwriters 130 to pay off all or part of a loan balance upon an event, such as default of the loan. In various embodiments, default may be determined in various ways, such as failure of the borrower 110 to pay the lender 120 one or more loan payments, delay of payment of one or more loan payments, one or more loan payments that are less than an agreed-upon amount, etc. In various embodiments, the LUS 100 may be configured to receive a default indication from the lender 120 and, based on this facilitate payment of all or part of the loan balance by the one or more loan underwriters 130. In various embodiments, events other than default may trigger payment by the one or more loan underwriters 130.

In various embodiments, the LUS 100 may be configured to facilitate underwriting by individuals acting as loan underwriters 130, such as individuals 133 and 135. In various embodiments, the LUS 100 may be configured to facilitate underwriting by non-individual loan underwriters, such as by organization 138, which, in various embodiments, may include for-profit and non-profit organizations.

In various embodiments, the LUS 100 may be configured to facilitate payment by the loan underwriters 130 of one or more individual payments. These individual payments may, when combined, constitute all or part of the loan balance that may be paid to the lender 120, such as upon indication of default. In various embodiments, the LUS 100 may be configured to facilitate payment of different individual payments by different underwriters 130; for example, as illustrated in the example of FIG. 1, loan underwriter 135 may pay a larger individual payment to the lender 120 than other loan underwriters, such as loan underwriters 133 and 138.

In various embodiments, the LUS 100 may be configured to facilitate underwriting by encumbering financial resources of the loan underwriters 130. For example, in various embodiments, the LUS 100 may be configured to obtain an authorization to take an individual payment amount from a loan underwriter 130 upon indication of default by the lender 120. In some embodiments, the LUS 100 may be configured to obtain an authorization to take the individual payment amount out of a bank account, line of credit, or credit card under control of a loan underwriter (referred to herein generally as “a line of credit”). In such embodiments, the LUS 100 may facilitate the lender 120 in lending a loan amount without a requirement that the one or more loan underwriters 130 provide funds or other collateral at the time of the loan. Instead, in such embodiments, the one or more loan underwriters 130 may agree to the authorization of an individual payment amount without needing to have the individual payments on-hand at the time the loan is agreed to. Additionally, a loan underwriter 130 may be facilitated by the LUS 100 in entering into agreements to underwrite the loan based on the loan underwriter's available credit, rather than other resources, such as liquid funds or other capital.

In various embodiments, the LUS 100 may be configured to facilitate collection and sharing of a premium from the borrower 110 to the one or more loan underwriters 130. Thus, in various embodiments, the LUS 100 may facilitate the division of an underwriting premium between various loan underwriters 130. In various embodiments, this division may be performed at least in part based on an amount of the individual payment the loan underwriter 130 has agreed to pay upon default. Thus, as shown, the individual loan underwriter 133, which has agreed to pay less of the payment than the individual loan underwriter 135, is also receiving a smaller individual premium. In various embodiments, the LUS 100 may be configured to facilitate collection of underwriting premiums and payment of individual premiums on a recurring basis, such as, for example, monthly or yearly.

In various embodiments, the LUS 100 may include one or more computing devices as described herein. In various embodiments the LUS 100 may include one or more modules configured to be operated on the one or more computing devices to perform techniques described herein. While particular modules are illustrated and described, in various embodiments, techniques described herein may be performed by other modules, combined into modules, and/or omitted. In various embodiments, the modules may be implemented as hardware and/or software components. The software components may be implemented in any one of a number of languages that may be assembled and/or compiled into instructions of the instruction set architecture of underlying processors.

In various embodiments, the LUS 100 may include borrower interface module 150, which may be configured to receive request for loan underwriting from a borrower 110. The borrower interface module 150 may also facilitate payment of underwriting premiums by the borrower 110. In various embodiments, the LUS 100 may include a lender interface 160 which may be configured to facilitate payment of a loan balance to the lender 120. In various embodiments, the LUS 100 may include a underwriter interface 170 which may be configured to receive offers to underwrite loans from the one or more loan underwriters 130, to facilitate payment of individual payments by the one or more loan underwriters 130, as well as to facilitate payment of divisions of premium amounts to the loan underwriters 130.

In various embodiments, the LUS 100 may include an underwriter identification module 180 which may be configured to select one or more loan underwriters 130 to underwrite a particular loan. Particular details of loan underwriter identification are described below. In various embodiments, the LUS 100 may also include a payment facilitation module 190. In various embodiments, the payment facilitation module 150 may be configured to divide received underwriting premiums between the one or more loan underwriters 130 and/or to facilitate payment of the divided premiums between the loan underwriters 130. In various embodiments, the payment facilitation module 150 may also be configured to facilitate payment from the loan underwriters 130 to the lender 120 after indication of default. In various embodiments, the payment facilitation module 150 may be configured to perform automated authorized payment from resources under control of the one or more loan underwriters 130, such as by obtaining authorization to pay from lines of credit and/or bank accounts under control of one or more loan underwriters 130. Examples of payment facilitation are described below.

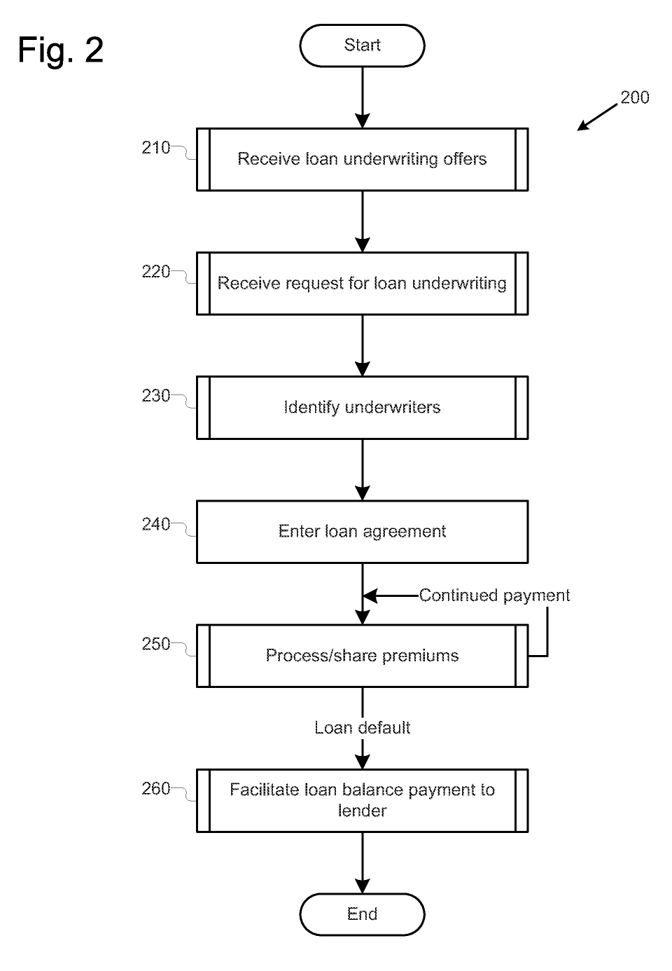

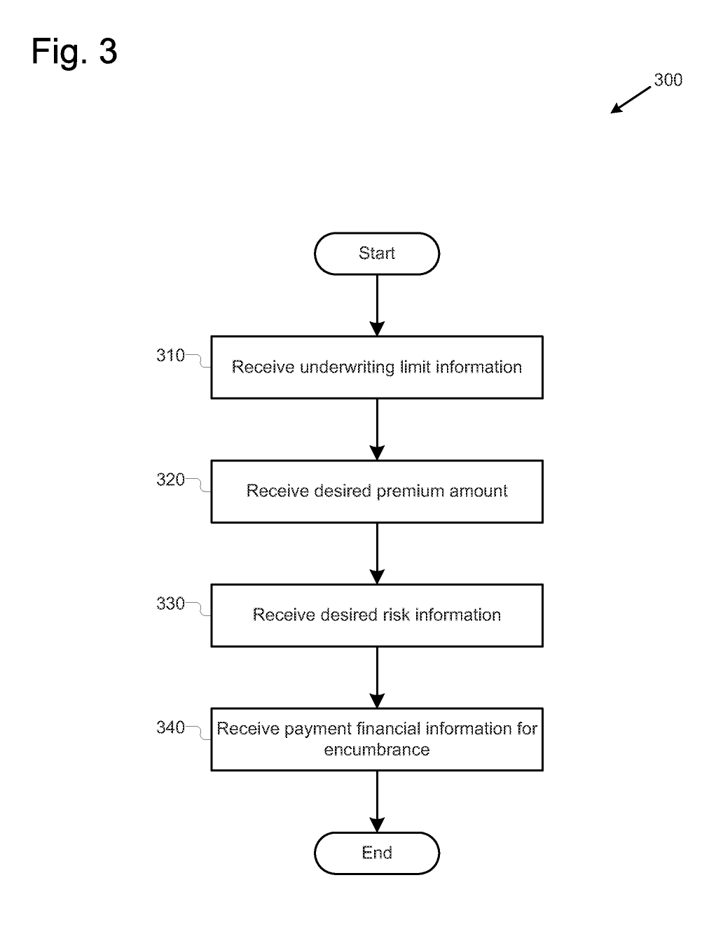

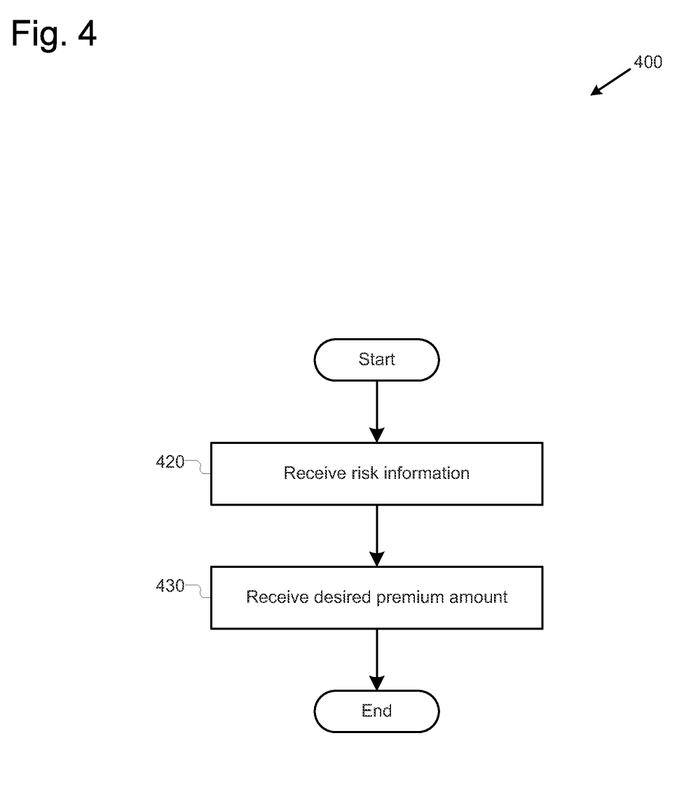

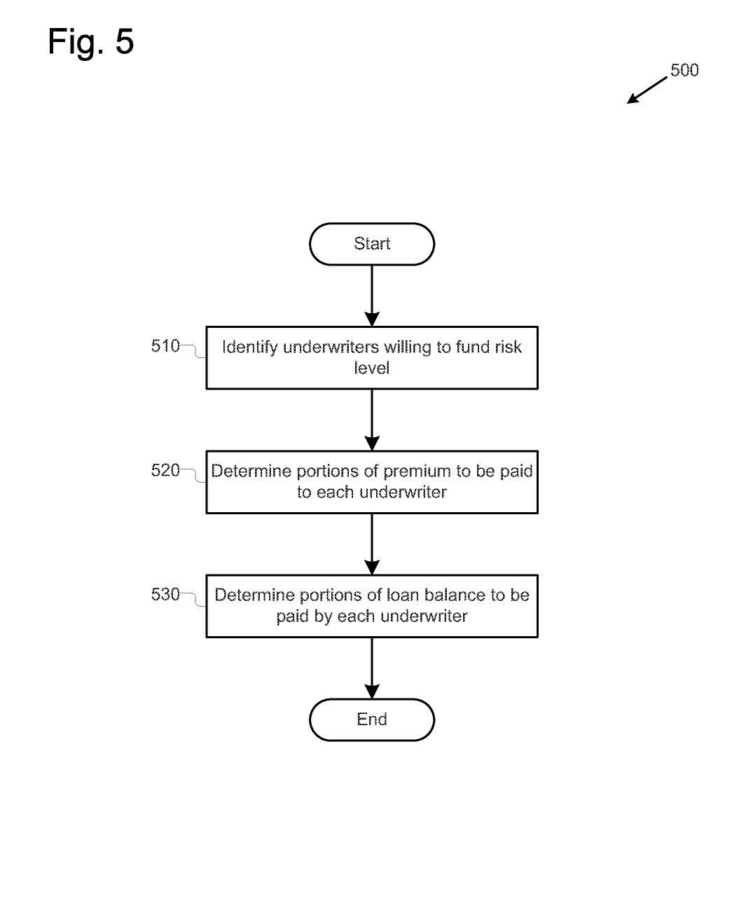

Referring now to FIG. 2, an example process 200 for facilitating underwriting of a loan is illustrated in accordance with various embodiments. While FIG. 2 illustrates particular operations in a particular order, in various embodiments, the operations may be combined, split into parts, and/or omitted. The process may begin at operation 210, where the LUS 100 may receive loan underwriting offers from one or more loan underwriters 130. Particular examples of operation 210 are described below with reference to FIG. 3. Next, at operation 220, the LUS may receive a request for loan underwriting from the borrower 110. Particular examples of operation 220 are described below with reference to FIG. 4. Next, at operation 230, the LUS 100 may identify one or more loan underwriters 130 for the loan. Particular examples of operation 230 are described below with reference to FIG. 5. Next, at operation 240, the borrower 110 and the lender 120 may agree to enter into a loan agreement based on the identified loan underwriters 130.

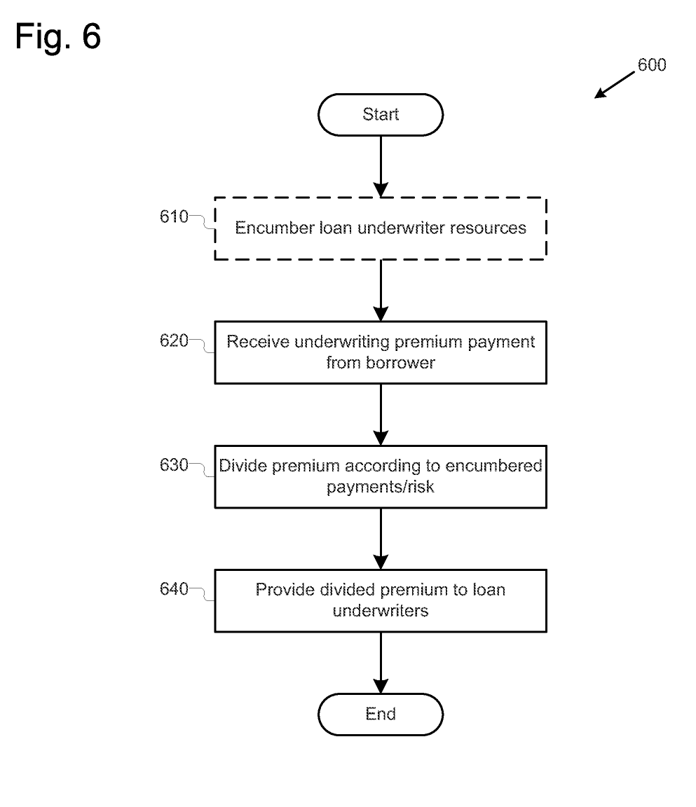

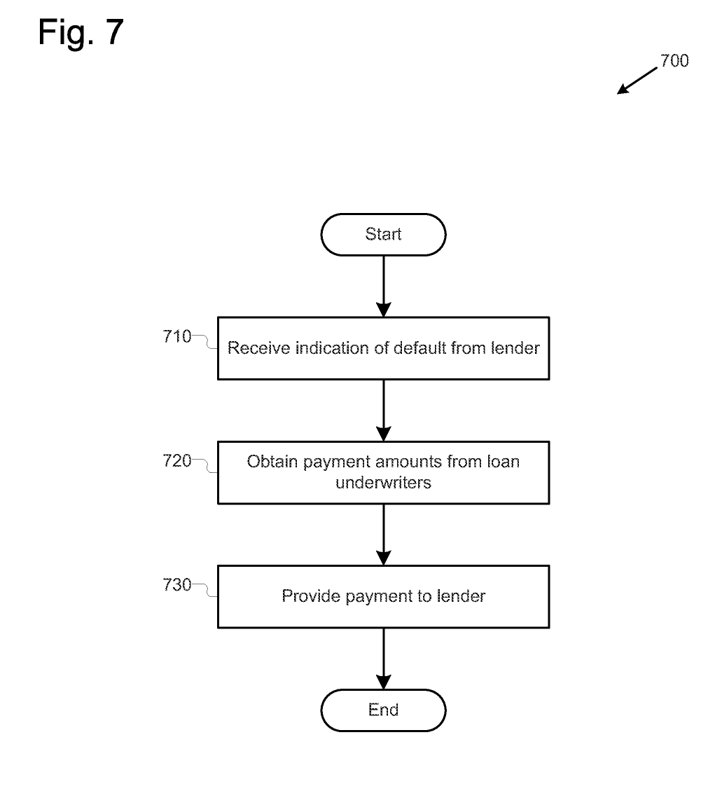

After agreement, at operation 250, the LUS 100 may facilitate processing and sharing of premiums received from the borrower 110 with the one or more loan underwriters 130. Particular examples of operation 250 are described below with reference to FIG. 6. In various embodiments, this sharing of premiums may repeat, such as so long as loan payments continue to occur and the borrower does not default on the loan. However, if the borrower does default on the loan, then at operation 260, the LUS 100 may facilitate automated payment of the loan balance to the lender 120. Particular examples of operation 260 are described below with reference to FIG. 7. The process may then end.

Referring now to FIG. 3, an example process 300 for receiving loan underwriting offers is illustrated in accordance with various embodiments. While FIG. 3 illustrates particular operations in a particular order, in various embodiments, the operations may be combined, split into parts, and/or omitted. In various embodiments, process 300 may be performed by the underwriter interface module 170. In various embodiments, process 300 may performed for each of one or more of the loan underwriters 130.

The process may begin at operation 310, where the LUS 100 may receive underwriting limit information for the loan underwriter 130. For example, the LUS 100 may receive an indication of maximum amount the loan underwriter 130 may be willing to underwrite. In various embodiments, at operation 310 the loan underwriter 130 may provide an indication of available credit limits and/or bank accounts that it is willing to authorize payment out of. In various embodiments, the underwriting limit information received at operation 310 may be indicated on a per-loan basis, and/or as a total limit on all loans to be underwritten by the loan underwriter 130.

Next, at operation 320, the LUS 100 may receive a desired premium amount from the loan underwriter 130. In various embodiments, the LUS 100 may facilitate indication of different desired premiums for different levels of underwriting; thus, a loan underwriter 130 may indicate that it is willing to provide additional underwriting for a higher received premium. Next, at operation 330, the LUS 100 may receive desired risk information. In various embodiments, the LUS 100 may thus receive an indication of a likelihood (which may be measured as a percentage or in some other metric) of a default occurring; this likelihood may then be associated with the loan underwriter 130's underwriting offer.

Next, at operation 340, the LUS 100 may receive financial information for the loan underwriter 130. In various embodiments, this financial information may be utilized by the LUS 100 to facilitate payment to the lender 120 upon occurrence of a default on a loan. In various embodiments, the financial information may facilitate the LUS 100 in encumbering the loan underwriter 130 to better ensure payment. For example, the LUS 100 may receive financial information that allows the LUS 100 to place a spending authorization against a line of credit of the loan underwriter 130. In various embodiments, this financial information may include one or more contract agreements between the loan underwriter 130 and the LUS 100 (or an entity associated with the LUS 100) to provide legal authorization for future payments. In various embodiments, the financial information received at operation 340 may include authorization for the LUS 100 to repeat obtaining authorization to encumber the loan underwriter 130, such as if a previous authorization times out. The process may then end.

Referring now to FIG. 4, an example process 400 for receiving a request for loan underwriting is illustrated in accordance with various embodiments. While FIG. 4 illustrates particular operations in a particular order, in various embodiments, the operations may be combined, split into parts, and/or omitted. In various embodiments, process 400 may be performed by the customer interface module 120.

The process may begin at operation 410, where the LUS 100 may receive risk information relating to the requested loan, such as from the borrower 110. In various embodiments, the risk information my include data relating to an actual numerical risk of a default occurring. In other embodiments, risk information may include information that facilitates the LUS 100 in determining risk, such as the borrower 110's current and/or historical financial information, history of repayment on other loans, etc. Next, at operation 430, the LUS 100 may receive a desired underwriting premium amount from the borrower 110. The premium amount, in various embodiments, may include an amount that the borrower 110 may be willing to pay per time period for underwriting of the particular loan being requested. The process may then end.

Referring now to FIG. 5 an example process 500 for identifying loan underwriters 130 is illustrated in accordance with various embodiments. While FIG. 5 illustrates particular operations in a particular order, in various embodiments, the operations may be combined, split into parts, and/or omitted. In various embodiments, process 500 may be performed by the underwriter identification module 180. As discussed above, in various embodiments, the LUS 100 may perform process 500 in order to identify one or more loan underwriters 130 that may be willing to underwrite a loan for the borrower 110.

The process may begin at operation 510, where the LUS 100 may identify potential loan underwriters 130 who have indicated they are willing to underwrite a particular risk level for the requested loan. In various embodiments, the risk level may be determined from the risk information provided at operation 420 of process 400. In some embodiments, the LUS 100 may identify those loan underwriters 130 that are willing to provide underwriting for lowest premium levels for the given risk, and/or at highest premium levels for the given risk.

Next, at operation 520, the LUS may determine the portions of the underwriting premium to be provided by the loan underwriters 130. In various embodiments, this determination may be based on the loan underwriter 130s′ underwriting limits as well as identified desired risks. Next, at operation 530, the LUS 100 may determine portions of the loan balance to be paid by each identified loan underwriter 130. The process may then end.

Referring now to FIG. 6, an example process 600 for sharing underwriting premiums is illustrated in accordance with various embodiments. While FIG. 6 illustrates particular operations in a particular order, in various embodiments, the operations may be combined, split into parts, and/or omitted. In various embodiments, process 600 may be performed by the payment facilitation module 190. The process may begin at operation 610, where the payment facilitation module 190 may encumber resources (such as lines of credit, credit cards, and/or bank accounts) of loan underwriters 130. In various embodiments, by encumbering resources, the LUS 100 may better ensured that individual payments used to generate a loan balance payment are available prior to payment of individual premiums to loan underwriters 130. In some embodiments, this operation may not be performed during every performance of process 600, such as when resources of one or more loan underwriters 130 are already encumbered. In some embodiments, however, if loan underwriter resources are not currently encumbered, such as due to a credit line authorization time limit, they may be re-encumbered at operation 610

Next, at operation 620, the LUS 100 may receive an underwriting premium payment from the borrower 110. In some embodiments, rather than receiving the premium payment directly, the LUS 100 may receive indication that the underwriting premium payment has been paid to another entity and/or directly to one or more loan underwriters 130. Next, at operation 630, the LUS 100 may divide the received premium. In various embodiments, this division may be performed according to the encumbered individual payment amounts and/or risk accepted by the loan underwriters 130. For example, in some embodiments, the premium may be divided between loan underwriters 130 as a pro rata share according to their amount of individual payment offered by each loan underwriter 130. Next, at operation 640, the LUS 100 may provide (or facilitate provision of) the divided underwriting premium to the loan underwriters 130. The process may then end.

Referring now to FIG. 7, an example process 700 for facilitating a loan balance payment is illustrated in accordance with various embodiments. While FIG. 7 illustrates particular operations in a particular order, in various embodiments, the operations may be combined, split into parts, and/or omitted. In various embodiments, process 700 may be performed by the payment facilitation module 190. The process may begin at operation 710, where the LUS 100 may receive an indication of a loan default. In various embodiments, the LUS 100 may receive the indication directly from the lender 120; in others, the LUS 100 may receive the indication of the default from the borrower 110 or from a different entity. Next, at operation 720, the LUS 100 may automatically obtain individual payment amounts from the loan underwriters 130. In various embodiments, the individual payment amounts may be obtained from pre-authorized lines of credit, credit cards, and/or bank accounts, such as discussed above. Next, at process 730, the LUS 100 may provide payment (or facilitate provision of payment) to the lender 120. The process may then end.

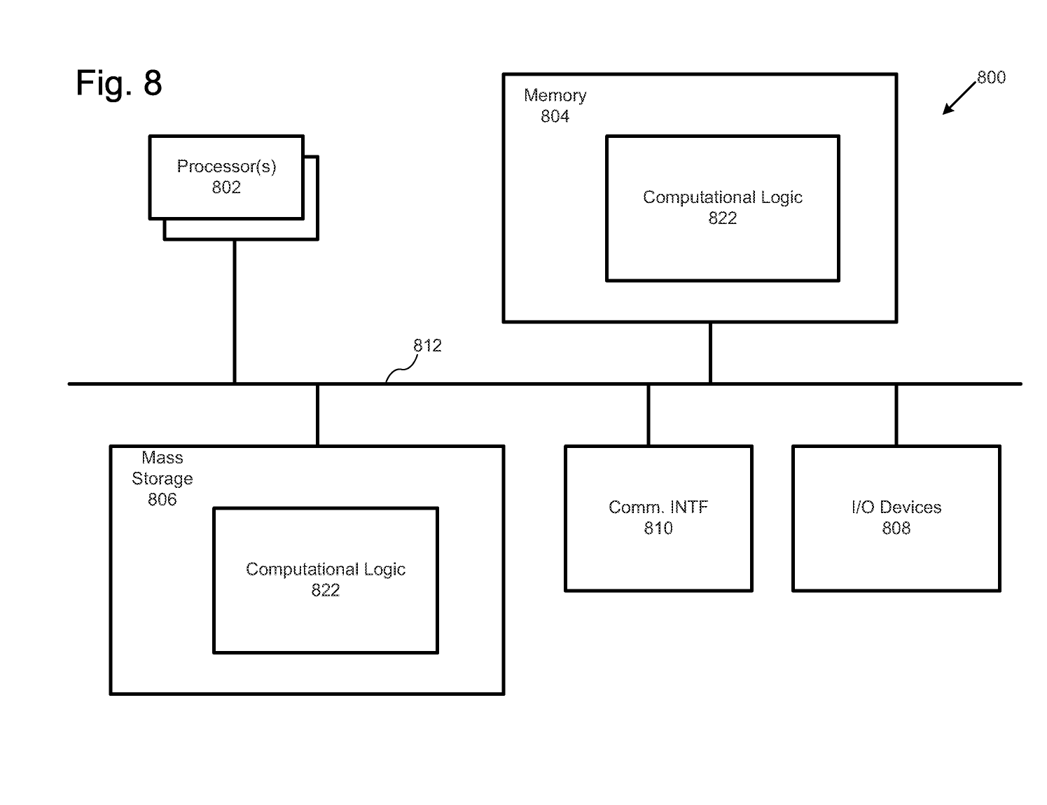

Referring now to FIG. 8, an example computer suitable for practicing various aspects of the present disclosure, including processes of FIGS. 2-7, is illustrated in accordance with various embodiments. As shown, computer 800 may include one or more processors or processor cores 802, and system memory 804. For the purpose of this application, including the claims, the terms “processor” and “processor cores” may be considered synonymous, unless the context clearly requires otherwise. Additionally, computer 800 may include mass storage devices 806 (such as diskette, hard drive, compact disc read only memory (CD-ROM) and so forth), input/output devices 808 (such as display, keyboard, cursor control, remote control, gaming controller, image capture device, and so forth) and communication interfaces 810 (such as network interface cards, modems, infrared receivers, radio receivers (e.g., Bluetooth), and so forth). The elements may be coupled to each other via system bus 812, which may represent one or more buses. In the case of multiple buses, they may be bridged by one or more bus bridges (not shown).

Each of these elements may perform its conventional functions known in the art. In particular, system memory 804 and mass storage devices 806 may be employed to store a working copy and a permanent copy of the programming instructions implementing the modules shown in FIG. 1, and/or the operations associated with techniques shown in FIGS. 2-7, collectively referred to as computing logic 822. The various elements may be implemented by assembler instructions supported by processor(s) 802 or high-level languages, such as, for example, C, that can be compiled into such instructions.

The permanent copy of the programming instructions may be placed into permanent storage devices 806 in the factory, or in the field, through, for example, a distribution medium (not shown), such as a compact disc (CD), or through communication interface 810 (from a distribution server (not shown)). That is, one or more distribution media having an implementation of the agent program may be employed to distribute the agent and program various computing devices.

The number, capability and/or capacity of these elements 810-812 may vary. Their constitutions are otherwise known, and accordingly will not be further described.

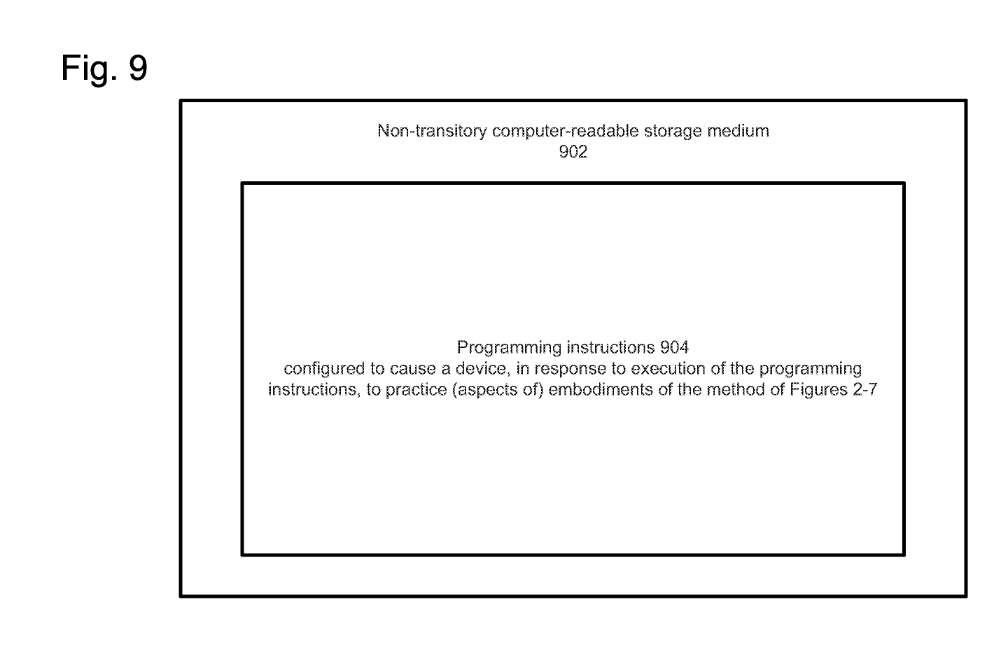

FIG. 9 illustrates an example least one computer-readable storage medium 902 having instructions configured to practice all or selected ones of the operations associated with the techniques earlier described, in accordance with various embodiments. As illustrated, least one computer-readable storage medium 902 may include a number of programming instructions 904. Programming instructions 904 may be configured to enable a device, e.g., computer 800, in response to execution of the programming instructions, to perform, e.g., various operations of processes of FIGS. 2-7, e.g., but not limited to, to the various operations performed to perform underwriting of loans. In alternate embodiments, programming instructions 904 may be disposed on multiple least one computer-readable storage media 902 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A computer-implemented method for facilitating underwriting of a loan, the method comprising:
receiving, by one or more computing devices, one or more offers associated with one or more loan underwriters to underwrite the loan, wherein the loan is associated with a borrower, a lender, and a loan balance; and
encumbering, by the one or more computing devices, one or more assets and/or lines of credit of the loan underwriters, such that upon a requirement to pay the loan balance to one or more lenders, the loan balance can be automatically taken from the one or more assets or lines of credit of the one or more loan underwriters.

2. The method of claim 1, wherein encumbering the one or more assets and/or lines of credit comprises encumbering individual assets and/or lines of credit for individual payment amounts that are less than the loan balance.

3. The method of claim 1, wherein encumbering the one or more assets and/or lines of credit comprises obtaining an authorization to take automated payment of an individual payment amount out of a credit card associated with an loan underwriter.

4. The method of claim 3, wherein:
the authorization has a time limit; and
the method further comprises obtaining re-authorization to take payment of the individual payment amount out of the credit card after completion of the time limit.

5. The method of claim 1, further comprising:
receiving, by the one or more computing devices, a payment of a premium from the borrower; and
paying, by the one or more computing devices, one or more portions of the premium amount to the one or more loan underwriters in exchange for the loan underwriters agreeing to allow encumbrance of the one or more assets and/or lines of credit.

6. The method of claim 1, further comprising:
receiving, by the one or more computing devices, an indication from the one or more lenders that the loan is in default; and
causing, by the one or more computing devices, the payment amount to be automatically taken from the one or more assets or lines of credit of the one or more loan underwriters.

7. The method of claim 1, further comprising:
receiving, by the one or more computing devices, a request for underwriting for the loan;
identifying, by the one or more computing devices, the one or more loan underwriters to underwrite the loan.

8. The method of claim 7, wherein:
the request for underwriting for the loan comprises risk information for the loan;
the one or more offers associated with the one or more loan underwriters include indications of desired risk for the one or more loan underwriters; and
identifying the one or more loan underwriters comprises identifying the one or more loan underwriters based at least in part on the risk information for the loan and the indications of the desired risk for the one or more loan underwriters.

9. One or more computer-readable media comprising instructions that, in response to execution on a computing device, cause the computing device to:
receive one or more offers associated with one or more loan underwriters to underwrite a loan associated with a borrower, a lender, and a loan balance; and
encumber one or more assets and/or lines of credit of the loan underwriters, such that upon a requirement to pay the loan balance to one or more lenders, the loan balance can be automatically taken from the one or more assets or lines of credit of the one or more loan underwriters.

10. The computer-readable media of claim 9, wherein encumber the one or more assets and/or lines of credit comprises encumber individual assets and/or lines of credit for individual payment amounts that are less than the loan balance.

11. The computer-readable media of claim 9, wherein encumber the one or more assets and/or lines of credit comprises obtain an authorization to take automated payment of an individual payment amount out of a credit card associated with an loan underwriter.

12. The computer-readable media of claim 11, wherein:
the authorization has a time limit; and
the instructions are further configured to cause the computing device to obtain re-authorization to take payment of the individual payment amount out of the credit card after completion of the time limit.

13. The computer-readable media of claim 9, wherein the instructions are further configured to cause the computing device to:
receive a payment of a premium from the borrower; and
pay one or more portions of the premium amount to the one or more loan underwriters in exchange for the loan underwriters agreeing to allow encumbrance of the one or more assets and/or lines of credit.

14. The computer-readable media of claim 9, wherein the instructions are further configured to cause the computing device to:
receive an indication from the one or more lenders that the loan is in default; and
cause the payment amount to be automatically taken from the one or more assets or lines of credit of the one or more loan underwriters.

15. The computer-readable media of claim 9, wherein the instructions are further configured to cause the computing device to:
receive a request for underwriting for the loan;
identify the one or more loan underwriters to underwrite the loan.

16. The computer-readable media of claim 15, wherein:
the request for underwriting for the loan comprises risk information for the loan;
the one or more offers associated with the one or more loan underwriters include indications of desired risk for the one or more loan underwriters; and
identify the one or more loan underwriters comprises identify the one or more loan underwriters based at least in part on the risk information for the loan and the indications of the desired risk for the one or more loan underwriters.

17. An apparatus for facilitating underwriting of a loan, the apparatus comprising:
one or more computer processors; and
a loan underwriter interface module configured to operate on the one or more computer processors to:
receive one or more offers associated with one or more loan underwriters to underwrite the loan, wherein the loan is associated with a borrower, a lender, and a loan balance; and
encumber one or more assets and/or lines of credit of the loan underwriters, such that upon a requirement to pay the loan balance to one or more lenders, the loan balance can be automatically taken from the one or more assets or lines of credit of the one or more loan underwriters.

18. The apparatus of claim 17, wherein encumber the one or more assets and/or lines of credit comprises encumber individual assets and/or lines of credit for individual payment amounts that are less than the loan balance.

19. The apparatus of claim 17, wherein encumber the one or more assets and/or lines of credit comprises obtain an authorization to take automated payment of an individual payment amount out of a credit card associated with an loan underwriter.

20. The apparatus of claim 19, wherein:
the authorization has a time limit; and
the one or more modules are further configured to obtain re-authorization to take payment of the individual payment amount out of the credit card after completion of the time limit.

21. The apparatus of claim 17, further comprising a borrower interface module configured to operate on the one or more processors to:
receive a payment of a premium from the borrower; and
pay one or more portions of the premium amount to the one or more loan underwriters in exchange for the loan underwriters agreeing to allow encumbrance of the one or more assets and/or lines of credit.

22. The apparatus of claim 17, further comprising a lender interface module configured to operate on one or more processors to:
receive an indication from the one or more lenders that the loan is in default; and
cause the payment amount to be automatically taken from the one or more assets or lines of credit of the one or more loan underwriters.

23. The apparatus of claim 18, further comprising an underwriter identification module configured to operate on one or more processors to:
receive a request for underwriting for the loan;
identify the one or more loan underwriters to underwrite the loan.

24. The apparatus of claim 23, wherein:
the request for underwriting for the loan comprises risk information for the loan;
the one or more offers associated with the one or more loan underwriters include indications of desired risk for the one or more loan underwriters; and
identify the one or more loan underwriters comprises identify the one or more loan underwriters based at least in part on the risk information for the loan and the indications of the desired risk for the one or more loan underwriters.
